(19) United States
(12) Patent Application Publication
(10) Pub. No.: US 2004/0036587 A1
(43) Pub. Date: Feb. 26, 2004

(54) Vehicle collision detector and alert system

(76) Inventor: Derrick Howard Jefferson, San Leandro, CA (US)

Correspondence Address: Derrick Jefferson, Apt. 806, 2600 San Leandro Blvd., San Leandro, CA, 94578, US

(21) Appl. No.: 10/608,839

(22) Filed: Jun. 25, 2003

Related U.S. Application Data
(60) Provisional application No. 60/393,642, filed on Jul. 5, 2002.

(51) Int. Cl. B60Q 1/00

(52) U.S. Cl. 340/436

(57) ABSTRACT

Collision sensing devices connect to a main unit housing a plurality of electronics which include a cellular telephone circuit, a GPS receiver, and a compass circuit. Once a collision is detected, real-time geographical position and heading data are captured and sent to an emergency alert center where the data may be analyzed to determine the location of the vehicle in distress. Meanwhile, intense visual signals are transmitted from the exact location of the accident. The Vehicle Collision Detector also functions as a means for counterterrorism.

### BACKGROUND OF THE INVENTION

1. Field of the Invention

Method and apparatus for automatic vehicle accident detection and emergency alert of the vehicle's location, with visual signals, as well as the capacity for counterterrorism.

2. Related Art

Global positioning systems are widely known in which a plurality of satellites in earth's orbit are arranged to transmit signals such that a receiver located on the earth's surface is able, by triangulation techniques, to identify its location. Advances in such systems have resulted in them being included in small and relatively low cost equipment.

Global positioning systems are now in use to accomplish many tasks, including the navigation and monitoring of vehicles.

Nevertheless, our current state of GPS technology lacks a method and apparatus which is capable of rapidly meeting the global need to monitor terrorists and aid the prevention of future terrorist attacks. Todays GPS systems lack any need to be in personal vehicles for the basic reason that todays GPS systems specialize in diverse interests which vary from person to person, depending on his or her personal interests. Manufacturers and individuals in general lack interest in placing a device capable of monitoring vehicle location, even if it were to protect people for acts of terrorism, particularly because their just isn't enough need for such a device.

As a result, a large gap spans between existing needs to monitor and prevent terrorism and a rational, cost effective way to accomplish national and international goals for security against acts of terrorism.

While at the same time, a problem exists in the lack in most vehicles of an onboard vehicle collision detection device which provides a visual alert as well as a call for assistance. As a result, most vehicles are without the protection of any device which could provide rapid emergency assistance in the event of a vehicle collision.

### SUMMARY OF THE INVENTION

It is a main objective of the present invention to do two things: first, to provide a means for detecting a vehicle collision and to provide an alert for emergency assistance to a person, or persons, involved in a collision; second, to provide government officials a means to monitor the movement and location of suspected terrorists. In providing these capabilities, the Vehicle Collision Detector merges the needs of government and the public into one device which can meet the needs of vehicle operators worldwide while being affordable and convenient.

An all embodiment of the present invention, the Vehicle Collision Detector includes an angular velocity sensor, a Global Position System (GPS) receiver, a digital compass circuit, a programmed memory circuit, a cellular telephone circuit, a transmitting circuit, a timer circuit, an alpha-numeric keypad, a stop button, and a strobe light circuit.

It is another objective of the present invention to provide a vehicle collision detection system that is fully capable of providing an immediate response for emergency assistance to the scene of a vehicle collision, whether or not the victim, or victims, is conscious, by data obtained by the transmitting circuit from the GPS circuit. This data will be sent by the transmitting circuit via the cellular phone circuit to the the computers of emergency personnel.

It is another objective of the present invention to provide an automatic sensing system which responds to a calibrated sudden shift in velocity, yet allows for the operator of the vehicle to stop the function of a premature activation the of Vehicle Collision Detector's alert system. Since many factors may come into play in a vehicle accident, such as a rollover, a sensitive angular velocity device is needed for the detection of an accident. Yet, it should remain the choice of the vehicle operator if assistance is needed following an accident. For this purpose, a stop button is accessible on the Vehicle Collision Detector.

It is another objective of the present invention to provide a memory circuit and system thereof in which GPS, compass, and registration, data may be stored for the purpose of providing the transmitting circuit location, heading, and registration information upon an accident activated alert or incoming inquiry. It is within the memory circuit's scope for the memory circuit to receive additional information, such as drivers license number, for output upon the inquiries of the abovesaid input.

It is another objective of the present invention to provide a visual means for alert in the event of a vehicle accident. Since errors due to intentional or unintentional jamming can occur in global positioning systems as well as in wireless communication systems, both of which the vehicle Collision Detector depend on in the event of an accident, a visual alert device consisting of a strobe light, or intense light, circuit is part of the Vehicle Collision Detector, wherein a strobe/flashing light optionally may be connected and the light itself affixed to either windshield, or, as an option, both front and rear windshields. In the event of an accident, the angular velocity sensors activate the strobe light circuit which may consist of a trigger transformer, a trigger capacitor, a switcher transformer, a switcher transistor, and a flash capacitor. The flashing light, or lights, would be visible for a considerable distance as well as in harsh weather, when an accident is more likely.

In all, the foregoing objects can accomplish the above mentioned tasks of safety and security on a mass scale with the application of components that are cost-effective, serving both the government and the public, while overcoming the existing lack of the government's ability to get rapid, real time information on the location of an operator of a vehicle.

### BRIEF DESCRIPTION OF THE DRAWINGS

FIG. 1 is a diagram illustrating the components of the main unit of the Vehicle Collision Detector, including the angular velocity sensors and the strobe lights, according to a preferred embodiment of the present invention.

FIG. 2 is a diagram illustrating the major order of events from power source to a personal computer system receiving data from the vehicle collision detector, according to the first embodiment.

FIG. 3 is a flow diagram showing the execution and role of each process which exists within the Vehicle Collision Detector system of the first embodiment.

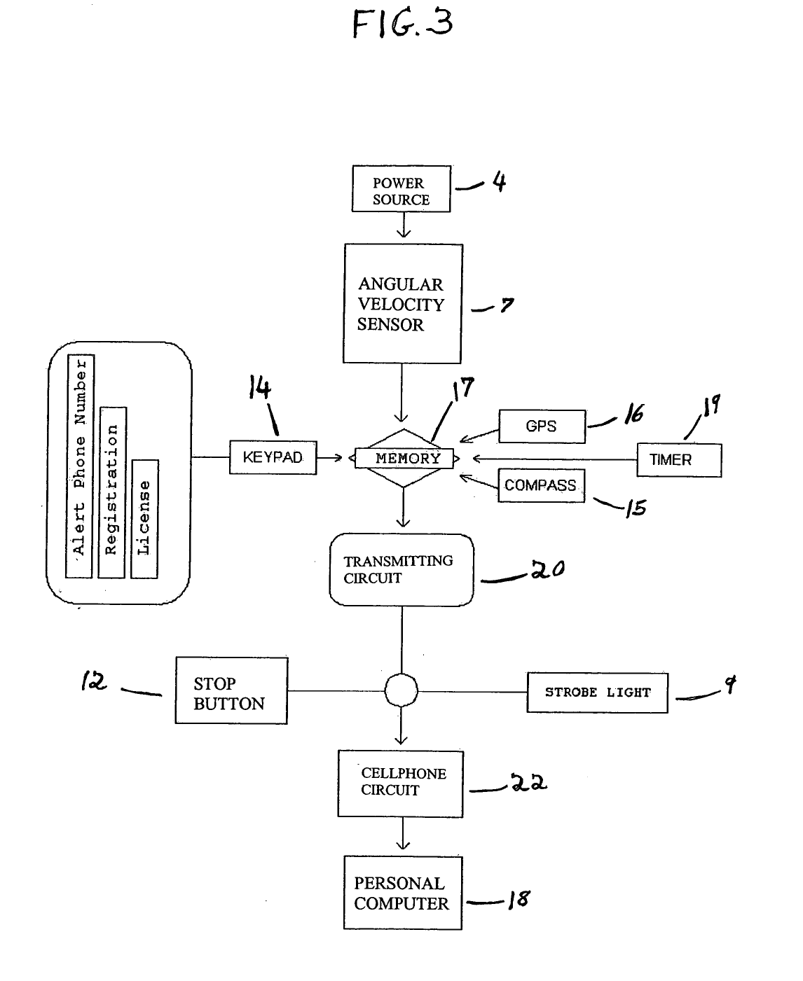

FIG. 4 is a top view illustration of the preferred positions of the strobe/flashing lights in a vehicle according to the first embodiment.

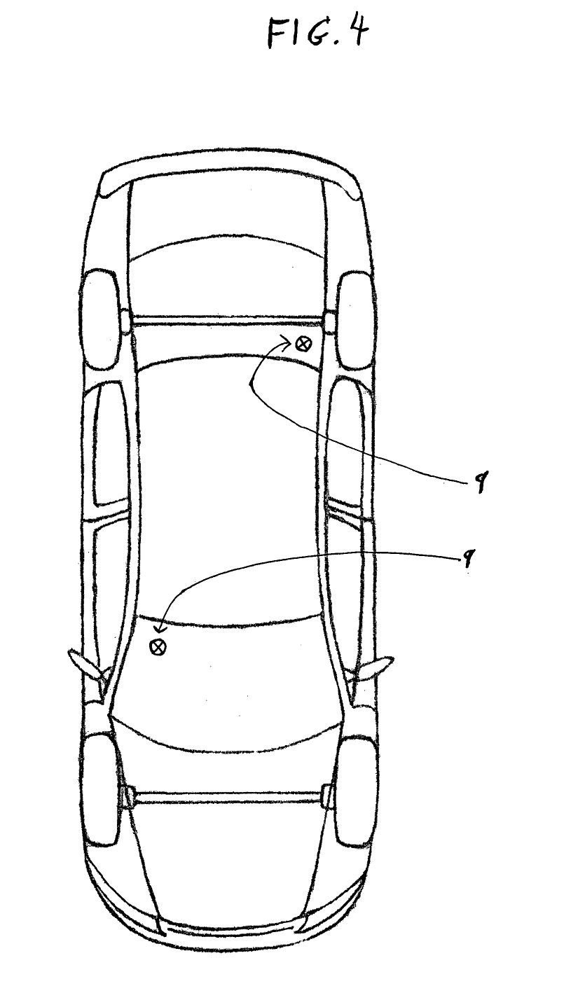

### DETAILED DESCRIPTION OF THE PREFERRED EMBODIMENTS

The present invention is described below for the detailed descriptions of the embodiment with emphasis upon road vehicle applications. The main focus of the invention is to provide a means for an emergency alert, in the event of an accident, whether or not the anyone involved in the accident is conscious.

The main focus of the invention is to be accomplished both by visual signals and by positional data.

Further, the present invention described below provides a means to monitor terrorists for the prevention of terrorism, while not being a stand alone function.

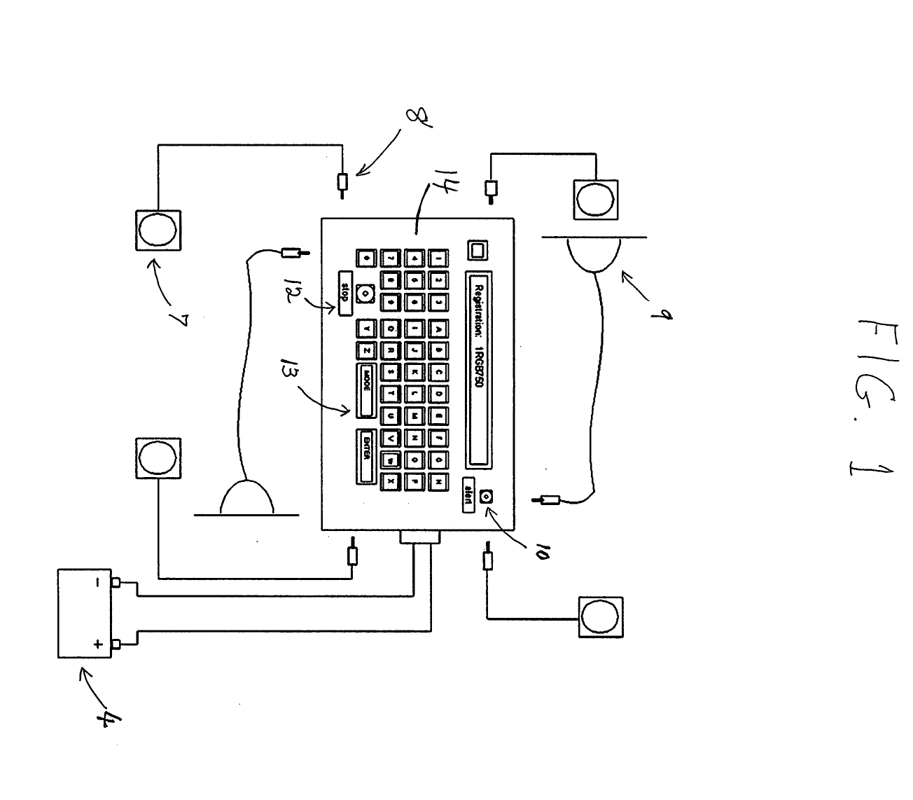

Referring initially to FIG. 1 there is shown components of the main unit which provide the user with a method to enter data and to receive emergency assistance following the event of an accident. Connected to the main unit by jacks are the velocity sensors 7 which will sense an impact above a calibrated value. Upon such an impact, the velocity sensors with initiate a series of events that will alert emergency personnel of the location and heading of the vehicle involved.

A strobe light 9, or otherwise a powerful flashing light, will also be activated, providing a visual signal which may be visible during harsh weather and visible from a long distance in good weather.

The alpha-numeric keypad 14 facilitates a method for inputting an emergency alert phone number, a registration number, and, optionally, a drivers license number. Any one of these three inputs may be selected for input by pressing the mode button, then entering the information.

In the system shown in FIG. 1, a stop button 12 provides the ability to end the process of an emergency alert.

If the need arises for emergency aid, an alert button 10, is provided to activate the emergency alert process.

An indicator light 10 will become active when the Vehicle Collision Detector is active.

The vehicle's battery 4 is used to provide power to a rechargeable power supply unit within the main unit of the Vehicle Collision Detector.

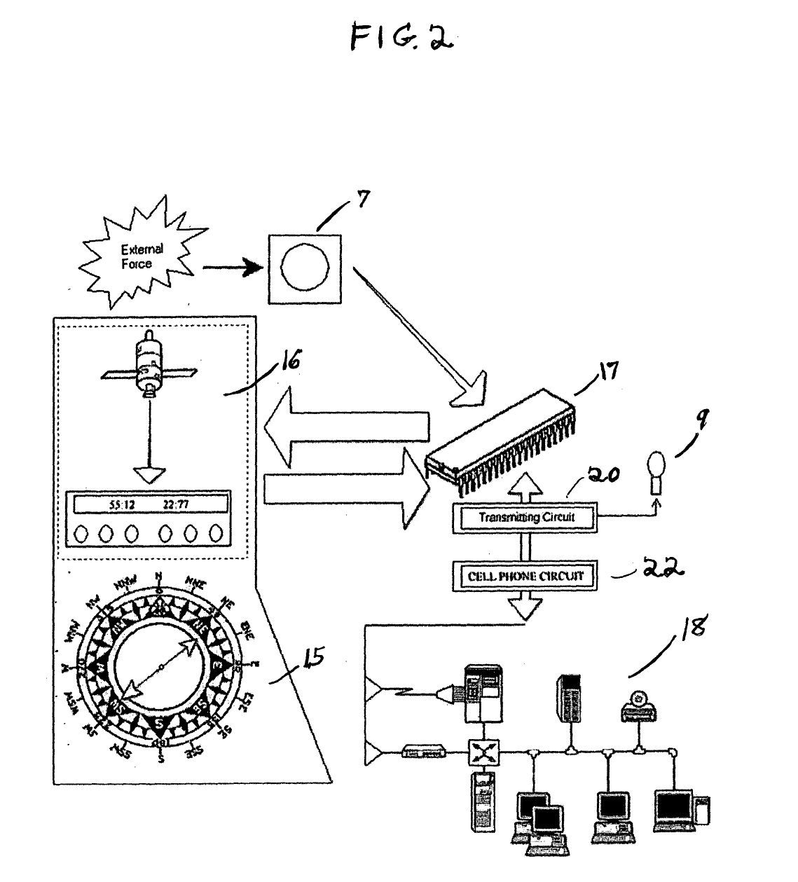

Referring to FIG. 2 the process comprising the Vehicle Detector System is illustrated. The impact of a collision triggers the velocity sensor 7, after which the memory circuit becomes active and captures current global positioning system receiver 16 data as well as compass 15 heading data.

The transmitting circuit 20 then sends the captured data, as well as input data, from the memory circuit 17 to the cellular phone circuit 22. Input data consists of an emergency alert phone number, a vehicle registration number, and (optionally) a driver's license number. Furthermore, input data is entered by the use of an alpha-numeric keypad 14, which includes a mode button 13 for selecting each particular input.

The data is the sent from the cellular phone circuit 22 to a personal computer system 18 where it is analyzed for geographical location and heading.

A timer 19 causes the memory circuit to repeat the process of data transfer at predetermined time intervals.

What is claimed is:

1. A method for transferring digital information over an air link while providing visual signals relative to a vehicle collision, or accident, to produce an emergency alert system comprising:
receiving signals having digital information from air link using circuitry contained in an electronics components housing object;
assisted by satellite, monitoring by receiving geographic position data of a geographically transiting object by recording of a first set of data representing the absolute geographic position of said object at first position, creating relative position data from a difference between the absolute position data of a given position and the position data of a proceeded recorded position, and recording a second set of position data representing a second position of said object relative to the first position;
obtaining said digital information, as well as compass and relative data input, by a personal computer system;
obtaining said digital information by active or passive methods, which may include counterterrorism.

2. A method as in claim 1, wherein said receiving step includes receiving said RF signals using a cellular telephone circuit.

3. A method as in claim 2, further comprising the step of:
providing a means for outputting digital information from said cellular telephone circuit.

4. A method as in claim 1, further comprising supplying the electrical power from the vehicle's battery to a rechargeable power unit within the Vehicle Collision Detector.

5. A method as in claim 3, wherein said output of said digital information is activated by a sensing apparatus, or by a manual action, or by a digital request from a remote sources.

6. A sensing apparatus, as in claim 5, wherein:
said sensing apparatus is activated by a force determined by a calibrated value.

7. A method for inputting data for storage and retrieval, by said method comprising:
an alpha-numeric keypad, including a mode button, and an enter button.

8. A method as in claim 7, wherein said storage of input is accomplished by a memory circuit.

9. A method as in claim 1, wherein said visual signals is comprised of:
an apparatus that flashes high emissions of light.

10. A method for transferring data from said data storage as in claim 8 to said cellular telephone circuit as in claim 2, said method comprising:
a circuitry for transmitting data from storage location to a cellular telephone circuit.

11. A method as in claim 1, wherein said transfer of data information is automatically repeated at predetermined time intervals.
